(19) United States
(12) Patent Application Publication
(10) Pub. No.: US 2025/0353229 A1
(43) Pub. Date: Nov. 20, 2025

(54) MOLDED LUBRICATION ADAPTOR ASSEMBLY WITH OIL FILTER HOUSING AND METHOD OF MAKING THE SAME

(71) Applicant: RB Distribution, Inc., Colmar, PA (US)

(72) Inventors: Robert PISCH, Willow Grove, PA (US); Douglas JOHNSON, Souderton, PA (US)

(73) Assignee: RB Distribution, Inc., Colmar, PA (US)

(21) Appl. No.: 19/202,325

(22) Filed: May 8, 2025

Related U.S. Application Data
(60) Provisional application No. 63/648,892, filed on May 17, 2024.

(51) Int. Cl. B29C 45/44; B29L 1/00; B29L 23/00; F01M 11/03

(52) U.S. Cl. CPC B29C 45/4457; F01M 11/03; B29K 2065/00; B29L 2001/00; B29L 2023/00

(57) ABSTRACT

A method of producing an engine oil adapter assembly, the method including forming a single polymeric body through a molding process. The body including a lower surface, an upper surface, a filter housing, a first connection interface, and a lubrication flow path. The lower surface being configured to mate with a lubrication network in an engine. The upper surface being configured to mate with a cooling component. The filter housing being defined at a first end of the body, and being configured to house an oil filter. The first connection interface being defined at the first end of the body at an end of the filter housing. The first connection interface being connectable to a cap. The lubrication flow path establishing a communication channel between the lubrication network and the filter housing. The method further provides a plurality of inserts being overmolded in the single polymeric body.

### CROSS-REFERENCE TO RELATED APPLICATIONS

This application claims the benefit of U.S. Provisional Patent Application No. 63/648,892, filed May 17, 2024, which is incorporated herein by reference as if fully set forth.

### TECHNICAL FIELD

The invention relates generally to the lubrication of mechanical engines that utilize oil as a lubricating fluid that circulates through defined galleries in the engine. More particularly, the invention relates to a lubrication system where the lubricating fluid is routinely passed through a filter element, which is generally replaceable at certain intervals, and potentially an oil cooler. Most particularly, the invention relates to an adaptor for a lubrication system that incorporates the oil filter and the oil cooler in an engine oil adaptor assembly that is often located within the motor valley.

### BACKGROUND

Modern engines, especially those used in motor vehicles, seek to reduce weight and size while maintaining the desired power. As part of the effort to reduce weight, many parts are being made in plastic and many parts are being combined in assemblies to further reduce weight by eliminating individual connection points. While this trend has proven successful in some areas, it has introduced problems where one or more portions of a plastic assembly experience a failure. Under these conditions, it is often necessary to disassemble unrelated parts of the engine in order to gain access to the assembly and make the necessary repairs.

Another drawback to some plastic assemblies is the need to make accommodations for various sensors and system components that need to be connected to the assembly. These connections are most often achieved by molding an opening in the plastic component and then attaching a metallic insert through a pressing or threading operation to achieve the connection. This plastic to metal connection can be difficult to properly seal. An additional failure point of this metal-plastic connector is the possibility of over tightening the connected component, such as a sensor fitting or cap, and stressing or damaging the surrounding plastic.

In addition to the above associated with a hybrid plastic-metallic assembly, the molding process requires certain concessions in order to permit molding cores to be inserted and removed as part of the molding process. An associated drawback with the plastic molding is the need to remove core elements used in the process and reseal the resulting molded component which can lead to further potential failure points. In addition, the unused molded openings require closing plugs that must be glued or welded in the unused openings. These plugs represent another potential failure point in the plastic-metallic assembly.

While the assignee of the present application has developed a one piece metallic part that addresses many of the drawbacks of the prior known molded plastic engine oil adaptor assemblies, further improvements that may reduce costs, improve manufacturability, and improve life as well as the ease of use are desired.

### SUMMARY

The applicants have discovered that a single polymeric body can be produced using a molding process to create a robust assembly, with the performance and durability being improved against burst pressure, heat and age degradation, and conditions related to cycling in comparison to prior known plastic assemblies. In addition, the single polymeric body produced using the molding process can provide a complete flow path without the need for adhesives, plastic welding, and/or resealing of the flow path.

In one aspect, a method of producing an engine oil adapter assembly is disclosed. The method can include forming, through a molding process, a single polymeric body. The single polymeric body can include a lower surface configured to mate with a lubrication network in an engine, and an upper surface configured to mate with a cooling component. Further, the single polymeric body can include a filter housing defined at a first end of the single polymeric body that is configured to house an oil filter. A first connection interface can be defined at the first end of the single polymeric body at an end of the filter housing, the first connection interface being connectable to a cap. Further, the single polymeric body can include a lubrication flow path that establishes a communication channel between the lubrication network and the filter housing. The method of producing the engine oil adapter assembly can also include a plurality of inserts being overmolded in the single polymeric body. Such a molding process eliminates the need for post-molding installed inserts as well as post-molding applied plugs.

Other features of the engine oil adapter assembly are described below.

### BRIEF DESCRIPTION OF THE DRAWINGS

The foregoing Summary as well as the following Detailed Description will be best understood when read in conjunction with the appended drawings, which illustrate a preferred embodiment of the disclosure. In the drawings:

FIG. 1 is a perspective view of an engine oil adapter assembly according to the present disclosure.

FIG. 2 is a top view of the engine oil adapter assembly of FIG. 1.

FIG. 3 is a side view of the engine oil adapter assembly of FIG. 1 and a cooling component.

FIG. 4 is a magnified detail view of a portion of the engine oil adapter assembly, as indicated in FIG. 3.

FIG. 5 is an end view of the engine oil adapter assembly of FIG. 1.

FIG. 6 is a partial top-perspective view of the engine oil adapter assembly of FIG. 1.

FIG. 7 is a cross-sectional view through an embodiment of the engine oil adapter assembly.

### DETAILED DESCRIPTION

Certain terminology is used in the following description for convenience only and is not limiting. The words “front”, “rear”, “upper”, and “lower” designate directions in the drawings to which reference is made. The words “inwardly” and “outwardly” refer to directions towards and away from parts referenced in the drawings. “Axially” refers to a direction along the axis of a shaft or cylindrically shaped component/feature. A reference to a list of items that are cited as “at least one of a, b, or c” (where a, b, and c represent the items being listed) means any single one of the items a, b, or c, or combinations thereof. The terms “generally” and “approximately” are to be construed as within 10% of a stated value or ratio. The terminology includes the words specifically noted above, derivatives thereof, and words of similar import.

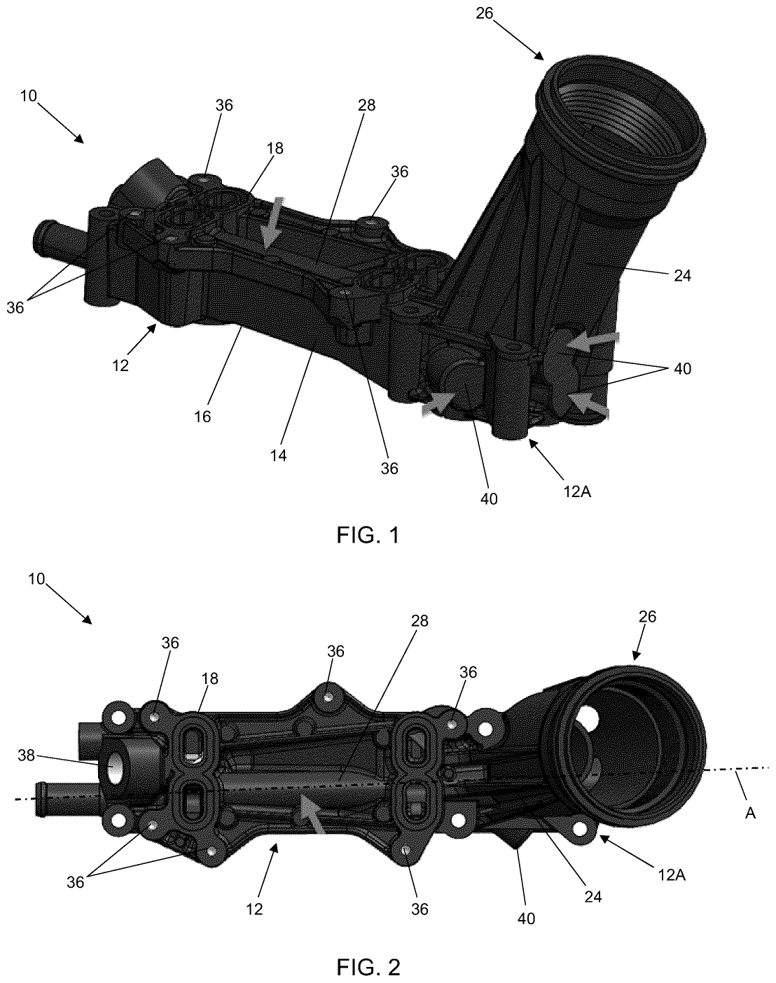

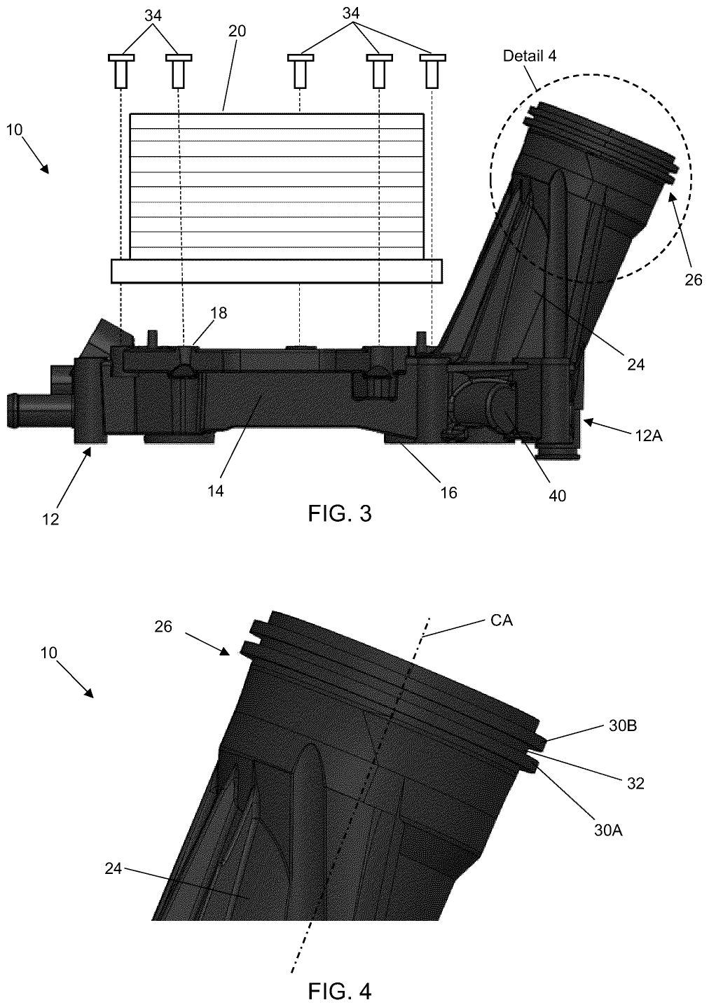

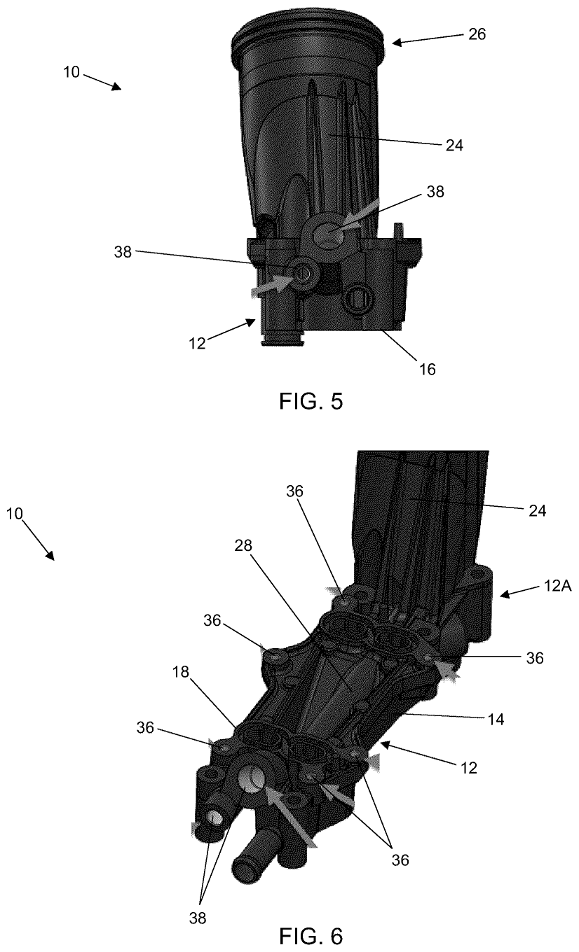

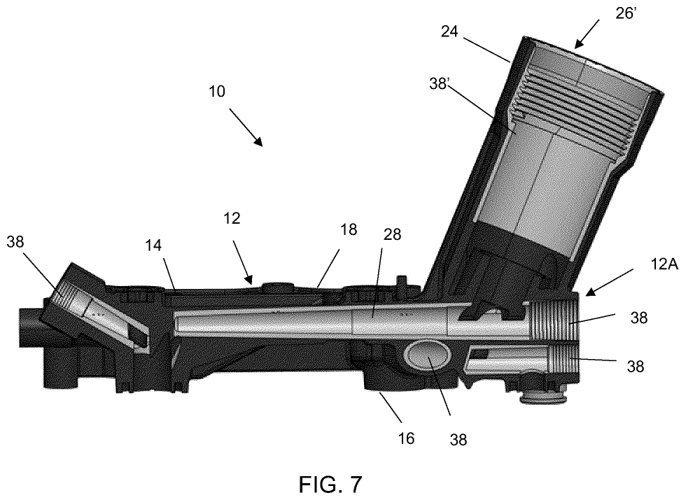

FIG. 1 is a perspective view of an engine oil adapter assembly 10 according to the present disclosure. FIG. 2 is a top view of the engine oil adapter assembly 10. FIG. 3 is a side view of the engine oil adapter assembly 10 and a cooling component 20 that is connectable to the engine oil adapter assembly 10. FIG. 4 is a magnified detail view of a portion of the engine oil adapter assembly 10, as indicated in FIG. 3. FIG. 5 is an end view of the engine oil adapter assembly 10. FIG. 6 is a partial top-perspective view of the engine oil adapter assembly 10. FIG. 7 is a cross-sectional view of an embodiment of the engine oil adapter assembly 10 which also includes an oil filter housing insert. FIGS. 1-7 will be discussed together.

The engine oil adapter assembly 10 is adapted to be utilized in a motor engine, such as an engine in a motor vehicle, to provide fluid flow paths and connection interfaces for other components, such as oil coolers, oil filters, caps, and sensors, among other options not specifically listed. Specifically, the engine oil adapter assembly 10 of the present disclosure is adapted for use with a cartridge-type oil filter (not shown), such as an OEM cartridge-type oil filter, discussed further below.

The engine oil adapter assembly 10 includes a molded single polymeric body 12 that is produced using a lost-core injection molding process. The single polymeric body 12 includes an elongated body portion 14 which includes a lower surface 16 configured to mate with the lubrication network in an engine (not shown), and an upper surface 18 configured to mate with a cooling component 20 (see FIG. 3), such as an OEM oil cooler. In some examples, as illustrated, the lower surface 16 and the upper surface 18 can be generally parallel to each other. The single polymeric body 12 also includes a filter housing 24 defined at a first end 12A of the single polymeric body 12. The filter housing 24 is configured to house an oil filter (not shown), such as an OEM cartridge-type oil filter. In some examples, as illustrated, the filter housing 24 can include a generally hollow-cylindrical shape with a central axis CA (see FIG. 4) extending centrally through the cylindrically shaped filter housing 24.

The single polymeric body 12 also includes a first connection interface 26 defined at the first end 12A of the single polymeric body 12. Further, the first connection interface 26 can be located and defined at an end of the filter housing 24. Specifically, the first connection interface 26 can be located and defined at the axial end of the filter housing 24 positioned furthest from the elongated body portion 14 of the single polymeric body 12. The first connection interface 26 is configured to be connectable to a cap (not shown), such as an OEM oil filter cap. The single polymeric body 12 also includes a lubrication flow path 28 that establishes a communication channel between the lubrication network, the filter housing 24, and the first connection interface 26. Specifically, the lubrication flow path 28 is formed integrally within the single polymeric body 12, entirely with the material used to produce the single polymeric body 12 during the molding process. Additionally, it is to be understood that each of the lower surface 16, the upper surface 18, and the filter housing 24, are formed integrally with the single polymeric body 12, entirely with the material used to produce the single polymeric body 12 during the molding process. In the embodiment of FIGS. 1-6, the first connection interface 26 is also formed integrally with the single polymeric body 12. However, as shown in FIG. 7, the first connection interface 26′ could also be formed with an over-molded oil housing insert, indicated as fluid insert 38′ in FIG. 7, as describe in detail below

As illustrated best in FIG. 2, the lubrication flow path 28 is centered along the longitudinal axis A of the single polymeric body 12, and the lubrication flow path 28 is symmetric about the longitudinal axis A. In other words, the lubrication flow path 28 substantially extends the length of the elongated body portion 14 of the single polymeric body 12 in a direction parallel to the longitudinal axis A. With the exception of the lubrication flow path 28, the lubrication galleries and the location positions for associated components are identical to the OEM assembly so the engine oil adapter assembly 10 is a direct replacement for the OEM part, and no modifications or relocations of other components are necessary. Similarly, sensors (not shown) may be attached to the engine oil adapter assembly 10 in the same manner and location as the OEM part so the engine oil adapter assembly 10 functionally replaces the OEM part and no modifications or relocations of other components are necessary.

Referring to FIGS. 1 and 3, the first connection interface 26 is positioned on a same side of the single polymeric body 12 as the upper surface 18. More specifically, the first connection interface 26 is positioned on a same side of the single polymeric body 12 as the upper surface 18 and the first connection interface 26 faces in a direction away from the upper surface 18 at a non-parallel and non-perpendicular angle with respect to the upper surface 18. In some embodiments, as illustrated, the first connection interface 26 can face in a direction away from the upper surface 18, away from the lower surface 16, and away from the elongated body portion 14. It is to be understood that the exact location and angle of the first connection interface 26 can be altered to fit within a space envelope of the motor vehicle/engine in which the engine oil adapter assembly 10 is configured to be utilized. But, in the embodiments of FIGS. 1-6, the first connection interface 26 is formed integral with the single polymeric body 12, such that the first connection interface 26 and the single polymeric body 12 are formed from a single material as a single-piece component through the molding process. As noted above, it is also possible for the first connection interface 26′ to be formed with an overmolded oil housing insert, indicated as fluid insert 38′ in FIG. 7

The single polymeric body 12 also includes the filter housing 24 that extends between and connects the first connection interface 26 to the upper surface 18 of the single polymeric body 12. The filter housing 24 includes a generally hollow-cylindrical shape, such that an internal surface of the filter housing 24 defines a cavity that is configured to accept an oil filter, such as for example an OEM cartridge-type oil filter. As such, in operation, an oil filter can be inserted and secured within the internal surface (i.e., the cavity) of the filter housing 24, and a cap (not shown) can be coupled to the first connection interface 26 to fluidly seal the oil filter within the filter housing 24. The filter housing 24 is formed integral with the single polymeric body 12, such that the filter housing 24 and the single polymeric body 12 are formed from a single material as a single-piece component through the molding process.

The first connection interface 26, 26′ of the engine oil adapter assembly 10 is configured to be sealingly coupled to a second connection interface of an oil filter cap (not shown), such as an OEM oil filter cap, preventing fluid leakage between the cap and the first connection interface 26. In some examples, the second connection interface of the cap can include mating threads that are complementary to threads in the first connection interface 26′, shown for example in FIG. 7, allowing the first connection interface 26 and the second connection interface of the cap to be sealingly coupled together. In other non-illustrated examples, the first connection interface 26 and the cap may not include threads but instead may utilize a different approach for sealingly coupling the first connection interface 26 and the cap. In any example, the connection between the first connection interface 26 and the cap is configured to prevent fluid leakage between the components. When the cap is coupled to the first connection interface 26, the lubrication flow path 28 establishes a communication channel between the lubrication network of the engine, the filter housing 24, the oil filter positioned within the filter housing 24, and the first connection interface 26.

As illustrated best in FIG. 4, the single polymeric body 12 can further include at least one circumferentially extending rib 30A, 30B positioned at or adjacent the first connection interface 26. The at least one circumferentially extending rib 30A, 30B can be formed integral with the single polymeric body 12, such that the at least one circumferentially extending rib 30A, 30B and the single polymeric body 12 are formed from a single material as a single-piece component through the molding process. The at least one circumferentially extending rib 30A, 30B can be formed and positioned on an outer circumference or surface of the first connection interface 26, such that the at least one circumferentially extending rib 30A, 30B is oriented concentric with the first connection interface 26. Additionally, the at least one circumferentially extending rib 30A, 30B can include a first rib 30A and a second rib 30B. The second rib 30B can be axially offset from the first rib 30A along the central axis CA of the filter housing 24, such that a gap 32 is defined between the first rib 30A and the second rib 30B.

The first rib 30A and the second rib 30B are intentionally molded on and concentric with the first connection interface 26 to increase the strength characteristics of the first connection interface 26. Specifically, the first rib 30A and the second rib 30B are provided to increase a hoop strength of the single polymeric body 12 at the first connection interface 26, which results in an increased torque rating that reduces the likelihood of failure of the first connection interface 26 and/or the filter housing 24 during installation and tightening of the cap to the first connection interface 26. In previous oil adapter assemblies that do not include the at least one rib 30A, 30B, cracking and other failures of the filter housing and/or the first connection interface have been known to occur due to over-tightening of the cap onto the first connection interface. The first rib 30A and the second rib 30B included in the single polymeric body 12 of the present disclosure prevents or reduces the aforementioned issues by increasing the strength and torque characteristics of the single polymeric body 12 at the location of tightening (i.e., the first connection interface 26).

Referring to FIGS. 1-3, 6 and 7, the engine oil adapter assembly 10 includes the upper surface 18 which is configured to mate with the cooling component 20 (illustrated only in FIG. 3), such as an OEM oil cooler. Specifically, the cooling component 20 can be mounted to the upper surface 18 of the elongated body portion 14 of the single polymeric body 12 via bolts 34. As illustrated best in FIGS. 1-2 and 6, the single polymeric body 12 can further include a plurality of inserts located in the elongated body portion 14. Specifically, the single polymeric body 12 can include a plurality of threaded inserts 36 (see FIGS. 1-2) that are overmolded in the single polymeric body 12 during the molding process, and are positioned adjacent the upper surface 18 of the single polymeric body 12. Each of the plurality of threaded inserts 36 include internal threads that are configured to directly receive and mate with external threads of the bolts 34 to secure the cooling component 20 to the single polymeric body 12.

As such, a threaded insert 36 is overmolded into the single polymeric body 12 at the desired location for each fastener that is to be connected into the single polymeric body 12 through an overmolding manufacturing process. Therefore, during the molding or production process of the single polymeric body 12, each of the threaded inserts 36 are placed in their desired position in the mold used to produce the single polymeric body 12. Then the molding process (for example, a lost-core injection molding process with the core defining the internal fluid channels) is performed and each of the threaded inserts 36 are overmolded such that they are properly located at each desired fastener receiving location, and a material bond is formed between the exterior surface of the threaded inserts 36 and the single polymeric body 12, which secures the threaded inserts 36 in the desired position.

The specific number of threaded inserts 36 will depend on the specific configuration of the cooling component 20 and/or the single polymeric body 12. Each of the threaded inserts 36 are configured to include internal threads that are configured to mate with the external threads of the bolts 34 (see FIG. 3). As such, the bolts 34 can be threaded into the threaded inserts 36 to secure the cooling component 20 to the single polymeric body 12.

Additionally, the single polymeric body 12 can include a plurality of fluid inserts 38 (see FIGS. 6 and 7) located in the elongated body portion 14 that are arranged to provide connections to the internal fluid channels formed by the (lost) core that is positioned in the mold prior to injecting the polymeric material. Specifically, at least some of the plurality of fluid inserts 38 can be positioned adjacent at least one side surface or at least one end surface of the single polymeric body 12. The plurality of fluid inserts 38 are each configured to provide connection points for fluid conduits, fluid connectors, sensors, caps, or other fluidic components of the engine and/or motor vehicle to the internal fluid channels in the single polymeric body 12. As such, each of the plurality of fluid inserts 38 are configured to directly receive fluid adapters in a fluid tight manner, preventing fluid leakage between the components. The plurality of fluid inserts 38 can be configured to provide fluidic entry and/or exit points for the fluid (such as oil) that flows from the lubrication network of the engine (not shown) and through the engine oil adapter assembly 10.

Each of the plurality of fluid inserts 38 are formed by overmolding a fluid insert 38 into the single polymeric body 12 at the desired locations through the same overmolding manufacturing process as discussed above with reference to the threaded inserts 36. For the embodiment of FIG. 7, the fluid insert 38′ that forms the oil housing insert is also overmolded at the same time. Therefore, each of the fluid inserts 38 (and 38′ if present) are overmolded at the desired location to create a material bond between the external surface of the fluid inserts 38, 38′ and the single polymeric body 12, which secures the fluid inserts 38, 38′ in position at the desired locations and in communication with the internal fluid channels. The specific number of fluid inserts 38, 38′ will depend on the specific configuration of the single polymeric body 12. Each of the fluid inserts 38 are configured to include internal features that are configured to mate with external features of a fluid connector (not shown) or other component (such as a sensor fitting) to create a fluid tight connection. As such, after the fluid inserts 38 are overmolded in position, a fluid connector or other component can be coupled to the fluid inserts 38 in a fluid tight manner. Similarly the fluid insert 38′ that forms the oil housing insert includes the threads as the first connection interface 26 to which the cap can be sealingly engaged.

The overmolding manufacturing process used to fix or assemble the threaded inserts 36 and the fluid inserts 38, 38′ in position within the single polymeric body 12 provides benefits compared to previous fastening approaches. Specifically, compared to a heat staking, press-fitting, post-molding bonding, or external threading assembly process, the overmolding manufacturing process provides higher adhesion and pull-out strength characteristics between the single polymeric body 12 and the inserts 36,38. Additionally, the overmolding manufacturing process prevents fluid leakage from between the single polymeric body 12 and the inserts 36,38, 38′ due to the higher adhesion, compared to the heat staking, press-fitting, post-molding bonding, or external threading assembly processes which may experience issues of fluid leakage due, for example, to manufacturing defects and/or cyclic vibration wear causing loosening of the inserts at their mounting positions. Therefore, the overmolding manufacturing process used to fix or assemble the threaded inserts 36 and the fluid inserts 38, 38′ in position within the single polymeric body 12 can create a stronger and longer lasting material bond between the components, compared to previous approaches, while also preventing fluid leakage between the components.

The single polymeric body 12 can further include a plurality of internal fluid channels formed within the single polymeric body 12 that are defined by the (lost) core that is positioned in the mold prior to injection of the polymeric material used to form the single polymeric body. The core can be of a known type for lost cores, such as a sand and binder mix, that can be removed after the molding is completed, for example by being broken up through vibration or in any other known manner. Each of the plurality of fluid channels that do not require a fluid connection can include end plugs 40 (see FIG. 1) that may be integrally formed within the single polymeric body 12. In other words, each of the end plugs 40 are formed integral with the single polymeric body 12, such that the end plugs 40 and the single polymeric body 12 are formed from a single material as a single-piece component through a molding process. Forming the end plugs 40 integrally with the single polymeric body 12 eliminates the need for installation of end caps through a separate, post-molding gluing or plastic welding process. The aforementioned glued or plastic welded end caps are known to be potential fluid leakage points within previous engine oil adapter assemblies. Therefore, integrally forming the end plugs 40 within the single polymeric body 12 removes potential leakage points that may be present in the original or OEM design, creating a more robust and reliable engine oil adapter assembly 10, compared to previous designs and approaches.

The engine oil adapter assemblies 10 disclosed with reference to FIGS. 1-7 provides a solution for easily changing and replacing oil filters in motor engines/vehicles while minimizing or eliminating the risk of damaging the adapter assembly 10 during the filter replacing process, which can occur with OEM assemblies. As will be appreciated by a person having ordinary skill in the art, the angle in which the first connection interface 26, 26′ and the oil filter are positioned relative to the single polymeric body 12 and/or the elongated body portion 14 allows oil to drain back into the single polymeric body 12 and the lubrication network of the motor vehicle, reducing or eliminating oil spillage during the removal and replacement process.

Additionally, the engine oil adapter assemblies 10 of the present disclosure being manufactured as a single polymeric body 12 using a lost-core injection molding process with overmolded inserts allows the assembly to be manufactured as a single-piece component, thus removing glued/welded caps and potential failure/fluid leakage points, as on the OEM assembly. The engine oil adapter assemblies 10 of the present disclosure can further be manufactured using polyphenylene sulfide (PPS), which provides higher mechanical and thermal properties compared to one known OEM material, PA 66 nylon (i.e., nylon 66). The higher mechanical and thermal properties of PPS can further aid in a robust assembly 10 that prevents or minimizes potential for failure which would result in fluid leakage. Also, the one or more concentric ribs 30A,30B added around the first connection interface 26 increase the strength and torque rating of the assembly 10, which reduces the likelihood of failure during installation of the cap. It is also possible to use the fluid insert 38′ as the oil housing insert to provide increased strength. The plurality of inserts 36, 38, 38′ being assembled to the single polymeric body 12 using the overmolding manufacturing process also provides a stronger bond between components and prevents potential failure/fluid leakage points. The engine oil adapter assemblies 10 of the present disclosure provides many advantages compared to previous approaches and solutions, as will be appreciated by a person having ordinary skill in the art.

Having thus described the present embodiments in detail, it is to be appreciated and will be apparent to those skilled in the art that many physical changes, only a few of which are exemplified in the detailed description of the disclosure, could be made without altering the inventive concepts and principles embodied therein. It is also to be appreciated that numerous embodiments incorporating only part of the preferred embodiment are possible which do not alter, with respect to those parts, the inventive concepts and principles embodied therein.

The present embodiment and optional configurations are therefore to be considered in all respects as exemplary and/or illustrative and not restrictive, the scope of the disclosure being indicated by the appended claims rather than by the foregoing description, and all alternate embodiments and changes to this embodiment which come within the meaning and range of equivalency of said claims are therefore to be embraced therein.

### LOG OF REFERENCE NUMERALS

10 Engine Oil Adapter Assembly
12 Single Polymeric Body
12A First End
14 Elongated Body Portion
16 Lower Surface
18 Upper Surface
20 Cooling Component
24 Filter Housing
26, 26′ First Connection Interface
28 Lubrication Flow Path
30A First Rib
30B Second Rib
32 Gap
34 Bolts
36 Threaded Inserts
38, 38′ Fluid Inserts
40 End Plugs
A Longitudinal Axis
CA Central Axis

What is claimed is:

1. A method of producing an engine oil adapter assembly, the method comprising:
forming, through a molding process, a single polymeric body having:
a lower surface configured to mate with a lubrication network in an engine;
an upper surface configured to mate with a cooling component;
a filter housing defined at a first end of the single polymeric body that is configured to house an oil filter;
a first connection interface defined at the first end of the single polymeric body at an end of the filter housing, the first connection interface being connectable to a cap;
a lubrication flow path that establishes a communication channel between the lubrication network and the filter housing; and
a plurality of inserts overmolded in the single polymeric body.

2. The method of claim 1, further comprising forming at least one circumferentially extending rib at the first connection interface during the forming of the single polymeric body through the molding process.

3. The method of claim 2, further comprising forming the at least one circumferentially extending rib on an outer circumference or surface of the first connection interface, such that the at least one circumferentially extending rib is oriented concentric with the first connection interface.

4. The method of claim 2, wherein the at least one circumferentially extending rib comprises a first rib and a second rib, the second rib being axially offset from the first rib along an axis of the filter housing such that a gap is defined between the first rib and the second rib.

5. The method of claim 1, wherein at least some of the plurality of inserts are threaded inserts that are positioned adjacent the upper surface of the single polymeric body.

6. The method of claim 5, wherein the threaded inserts include internal threads that are configured to directly receive threaded fasteners to secure the cooling component to the single polymeric body.

7. The method of claim 1, wherein at least some of the plurality of inserts are fluid inserts that are positioned adjacent at least one side surface or at least one end surface of the single polymeric body.

8. The method of claim 7, wherein the fluid inserts are configured to directly receive fluid adapters in a fluid tight manner.

9. The method of claim 1, wherein at least one of the plurality of inserts is an oil housing insert.

10. The method of claim 9, wherein the oil housing insert includes the first connection interface.

11. The method of claim 1, further comprising forming fluid channels within the single polymeric body that include end plugs that are integrally formed entirely with material of the single polymeric body during the molding process.

12. The method of claim 11, further comprising forming the lubrication flow path integrally within the single polymeric body entirely with material of the single polymeric body during the molding process.

13. The method of claim 1, wherein the molding process is a lost-core injection molding process.

14. The method of claim 1, further comprising constructing the single polymeric body from polyphenylene sulfide (PPS).

15. An engine oil adapter assembly produced using the method of claim 1, wherein the engine oil adapter assembly is configured to accept and house a cartridge-type oil filter within the filter housing of the engine oil adapter assembly.
